(19) United States
(12) Patent Application Publication
(10) Pub. No.: US 2007/0023351 A1
(43) Pub. Date: Feb. 1, 2007

(54) Pivotable leg assembly for use with a colander

(76) Inventors: Eric R. Colburn, Wexford, PA (US); Thomas J. DeBlasis, Pittsburgh, PA (US); Conor P. McNamara, Brooklyn, NY (US)

Correspondence Address: SEYFARTH SHAW LLP, 131 S. DEARBORN ST., SUITE2400, CHICAGO, IL, 60603-5803, US

(21) Appl. No.: 11/190,765

(22) Filed: Jul. 27, 2005

(51) Int. Cl. B01D 35/02

(52) U.S. Cl. 210/464; 210/541; 99/485

(57) ABSTRACT

A pivotable leg assembly for use with a colander is disclosed including a housing having an engagement end for engaging a colander body, a leg pivotably engaged to the housing, and a biasing mechanism coupled to the leg and positioned within the housing, wherein the biasing mechanism provides resilient bias against pivoting the leg from either a first position or a second position.

### TECHNICAL FIELD

The present invention relates generally to devices intended for straining and rinsing foods, and more particularly to a pivotable leg assembly for use with a colander that can support the colander in a plurality of positions.

### BACKGROUND

The use of colanders or strainers for the purposes of rinsing contaminants from fruit, vegetables and the like, and for draining water or other liquids from pastas and other foods after cooking is well known. Generally, the colanders of the prior art have a structure that permits for suspending of the contents of the colander above a sink basin into which the rinse water, cooking water or other liquid is to be drained for disposal and/or to prevent contamination of the contents of the colander. Examples of such devices include colanders or strainers that include a base which rests on the bottom of the sink basin. Another example can incorporate an element such as a hanger that extends upwardly from the colander or strainer for attachment to or looping over a water faucet. In yet another example, the colander or strainer, or its handles, can be of sufficient size such that opposite ends thereof can rest on opposite rim or edge portions of the sink for suspending a bowl portion of the colander or strainer in or over the sink basin.

Such existing colanders and strainers have particular shortcomings, particularly where the base is placed in a contaminated sink basin, then onto a countertop, tabletop, or the like, where the contaminant can be transferred to the countertop or tabletop. In the second example above, the hanging means for suspending the colander over the sink from the water faucet can slide undesirably, interfering with the placement of items into the colander. Additionally, suspending a colander from the water faucet can also make it difficult to use the faucet. Regarding the third example, there is often difficulty in stowage and placement in dishwashers and the like, due to the large size of the colander or its handles.

### SUMMARY

This application discloses a pivotable leg assembly for use with a colander including a housing having an engagement end for engaging a colander body, a leg pivotably engaged to the housing, a biasing mechanism coupled to the leg and positioned within the housing, and wherein the biasing mechanism provides resilient bias to pivoting the leg between a first position and a second position.

A feature of the colander is the provision of a pivotable leg assembly incorporating a biasing mechanism that provides resilient bias when moving the leg between a first position and a second position, so that the leg is not inadvertently moved from the first or second position.

Another feature is the provision of a colander that can be both supported over a surface when the legs are in a first position and suspended over a sink basin when the legs are in a second position.

The disclosed colander is a significant enhancement of the typical construction of conventional colanders, wherein opposing pivotable leg assemblies that incorporate biasing mechanisms are connected to the colander.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of the preferred embodiment of the pivoting leg assembly;

FIG. 2 is a reduced, side elevational view of a pair of the leg assemblies of FIG. 1 in a first position “A” and attached to a colander;

FIG. 3 is a view similar to FIG. 2 with the leg assemblies in a second position “B”;

FIG. 4 is an end elevational view of the leg assembly of FIG. 1;

FIG. 4A is a fragmentary, cross-sectional view taken generally along line 4A-4A in FIG. 4;

FIG. 5 is a view similar to FIG. 4, with the leg assembly in the position “B” of FIG. 3;

FIG. 5A is a cross-sectional view taken generally along line 5A-5A in FIG. 5; and

FIG. 6 is an exploded perspective view of the leg assembly illustrated in FIG. 1.

### DETAILED DESCRIPTION

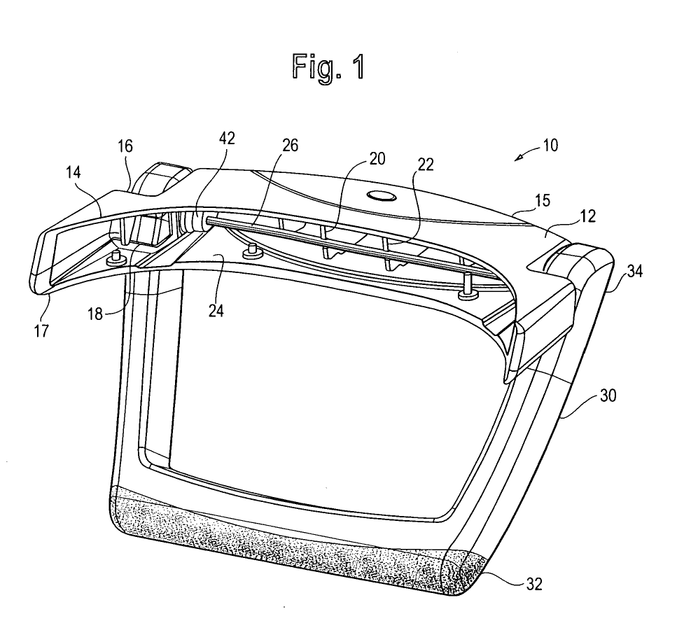

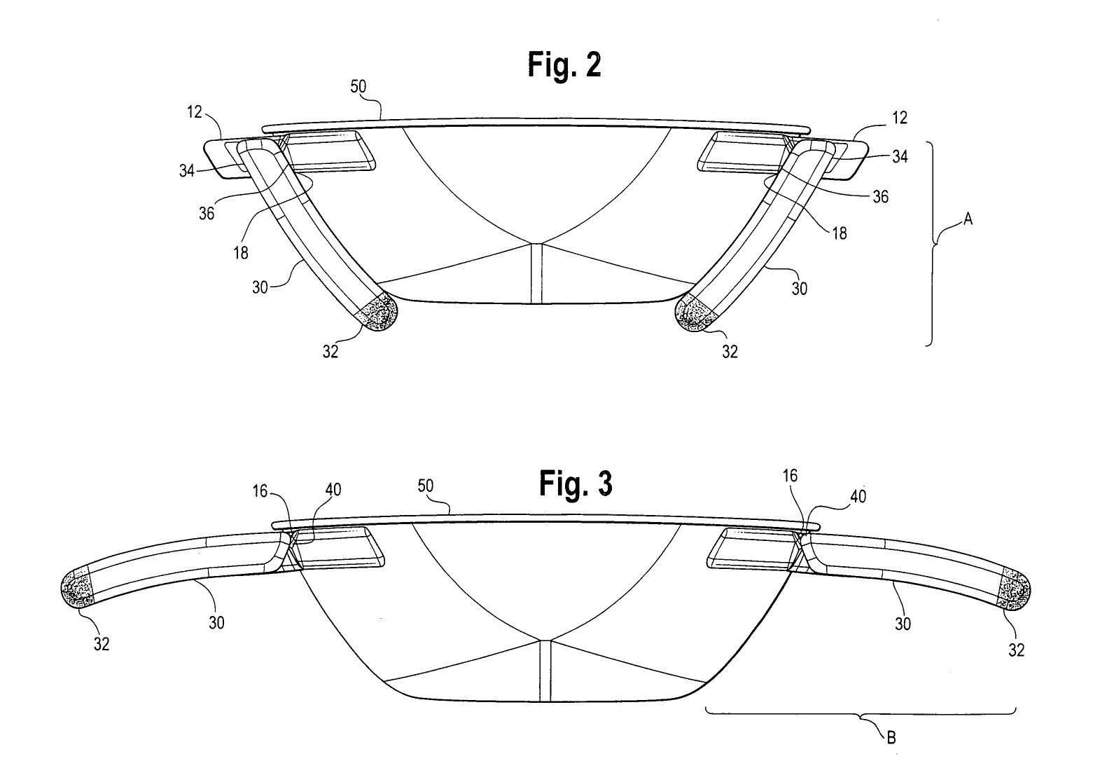

Referring now to FIGS. 1 and 6, there is illustrated a pivotable leg assembly 10, which includes a housing 12 and a generally U-shaped leg 30 that are engaged to one another in such a manner that leg 30 pivots with respect to housing 12, as detailed herein in connection with FIGS. 2, 3, 4A, and 5A.

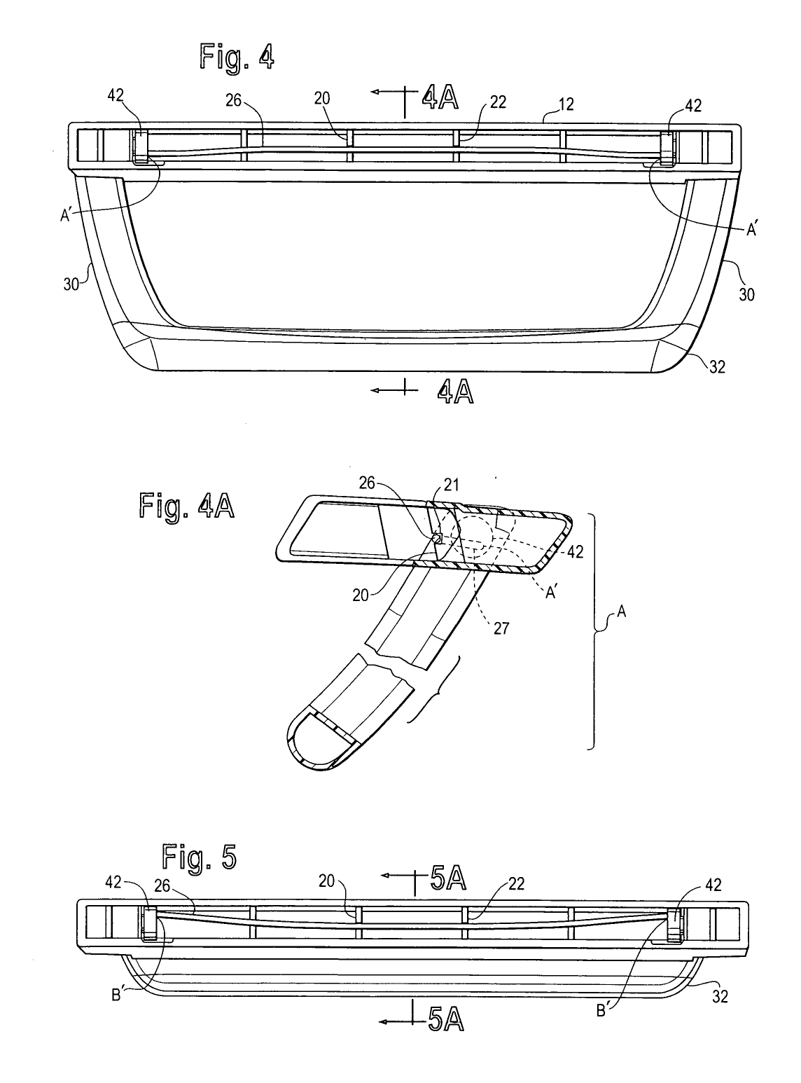

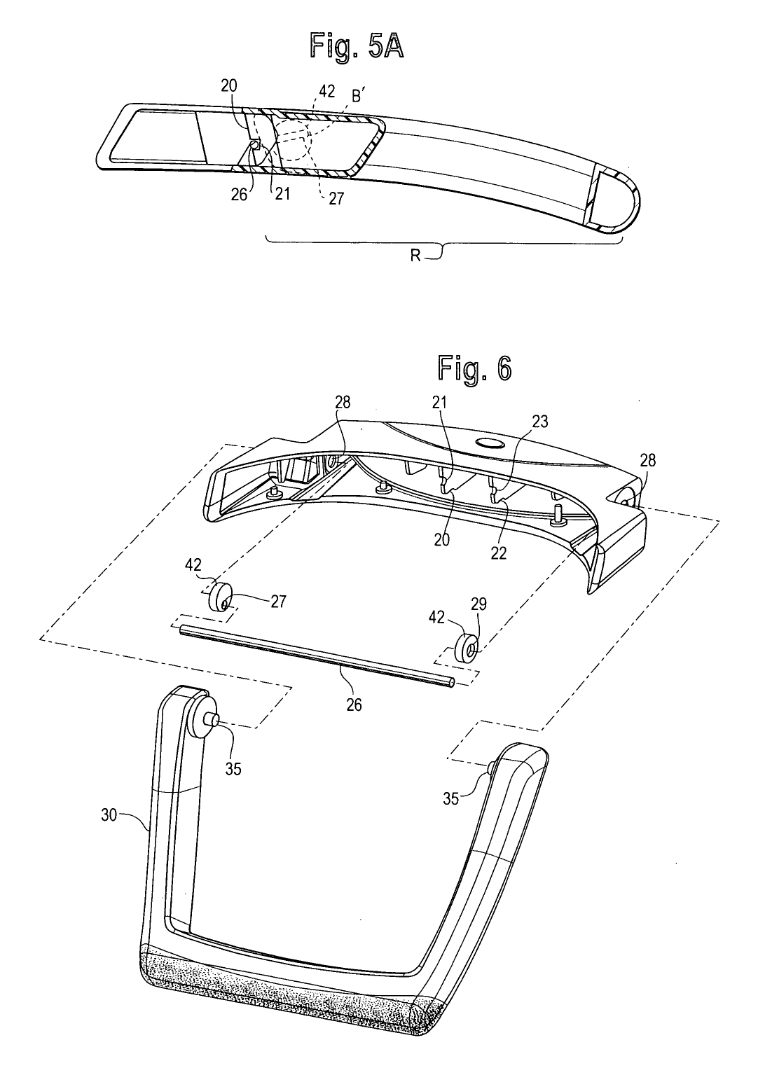

Housing 12 includes an engagement portion 14 for securing housing 12 to a structure, such as a colander 50 (see FIGS. 2 and 3). The housing 12 has upper and lower walls 15 and 17 joined by a side wall 19. Housing 12 may be notched or recessed at its opposite ends to define upper leg stops 16 and lower leg stops 18. Upper leg stops 16 prevent leg 30 from rotating too far in the direction of the upper wall 15 of housing 12. Similarly, lower leg stops 18 inhibit leg 30 from rotating too far in the direction of lower wall 17 of housing 12. As detailed further with respect to FIGS. 2 and 4A, the furthest point to which leg 30 can pivot before being halted by lower leg stop 18 is first position “A,” while, as illustrated in FIGS. 3 and 5A, the furthest point to which leg 30 can pivot before being halted by upper leg stop 16 is second position “B.” Positioned between upper wall 15 and lower wall 17 of housing 12 are brackets 20 and 22, as well as cavity 24. Cavity 24 provides an internal area to housing 12 that contains biasing mechanism 25 including a shaft 26, which is engaged to brackets 20 and 22 at notches 21 and 23 (FIG. 6), respectively. The biasing mechanism 25 also includes biasing wheels 42 respectively having eccentric openings 27 which respectively receive opposite ends of the shaft 26. Biasing wheels 42 are coupled to leg 30 in such a manner that the pivoting action of leg 30 causes biasing wheels 42 to rotate.

As is further illustrated in FIG. 1, leg 30 includes a bight forming a lower end 32 and a pair of upper ends 34. Lower end 32 may be covered with a material, such as a suitable elastomer, which increases the coefficient of friction of end 32 so that leg 30 will slide less on the substrate (sink, table, counter, or the like) that it contacts. Such friction enhancing materials include, but are not limited to, rubber and plastic materials.

Additionally, as shown in FIG. 6, housing 12 incorporates openings 28 for receiving pegs 35 of leg ends 34. Pegs 35 pass through openings 28 and mate leg engagement openings 29 of biasing wheels 42. The engagement between pegs 35 and openings 28 permit leg 30 to pivot with respect to housing 12.

Referring now to FIG. 2, two of the pivotable leg assemblies 10 are illustrated engaged, by any suitable means, to a colander 50. As shown, legs 30 are in first position “A” that places leg 30 adjacent to colander 50. In this manner, lower ends 32 of legs 30 may function as a stand for colander 50, keeping the bottom of colander 50 spaced above the substrate (not shown) that lower ends 32 contact. As further illustrated, each leg 30 includes inner surfaces 36 that contact lower leg stops 18 of housing 12, thereby preventing over-rotation of leg 30.

Referring now to FIG. 3, housings 12 of two pivotable leg assemblies 10 are again illustrated engaged to a colander 50. As shown, legs 30 are in second position “B” that places lower ends 32 of legs 30 away from colander 50. In this manner, lower ends 32 of legs 30 function to suspend colander 50 over, for example, a sink basin (not shown). Lower ends 32 would contact the substrate supporting the sink basin, such as a kitchen countertop, on two sides, thereby elevating colander 50 above the bottom of the sink basin. Legs 30 are further prevented from over-rotating by the contact between leg stops 40 of legs 30 and upper leg stops 16 of housings 12.

FIGS. 4 and 4A further illustrate first position “A” described with reference to FIG. 2. As shown, brackets 20 and 22 of housing 12 support shaft 26 of biasing mechanism 25. Biasing mechanism 25 may function as an over-centered spring, as is known in the art, that resiliently resists movement of leg 30 from either of first position “A” or second position “B.” The mating engagement between shaft 26 and biasing wheels 42 is preferably equally off of the center of the biasing wheels 42, as shown by position A′, so that shaft 26 is under greater biasing force when in first position “A” than in an intermediate position between A′ and B′. In this manner, lower end 32 of leg 30 is sufficiently maintained in first position “A” by the resistance of biasing mechanism 25 to forces applied when inadvertent attempts to move leg 30 are made. As illustrated in FIG. 4A, a portion of biasing mechanism 25 is supported in notch 21 of bracket 20 and mated at one end to an off-center opening 27, additionally illustrated in FIG. 6, of wheels 42. It is also preferred that biasing mechanism 25 be mated to off-center opening 27 in such a manner that biasing mechanism 25 is stretched as leg 30 is moved from first position “A” to second position “B.” Since the respective ends of biasing mechanism 25 are offset mounted to biasing wheels 42 with respect to the notches 21 and 23 of brackets 20 and 22, respectively, the biasing mechanism 25 is “over-centered” and serves to keep or securely resiliently bias the legs 30 in both the first position “A” and the second position “B” thereby maintaining the stability of the pivotable leg assembly 10 of the present invention when the legs 30 are in their two extreme operated positions (first position “A” and second position “B”). In this way, shaft 26 will provide resilient bias against moving out of first position “A” toward second position “B” as leg 30 is pivoted and coupled biasing wheels 42 are thereby rotated.

Referring now to FIGS. 5 and 5A, second position “B,” described with reference to FIG. 2, is illustrated. Again, brackets 20 and 22 of housing 12 support biasing mechanism 25, which is mated to a biasing wheels 42 at each of its ends. As stated previously, it is preferred that biasing mechanism be an over-centered spring that provides resistance when moved between second position “B” and first position “A.” The mating engagement between biasing mechanism 25 and biasing wheels 42 is preferably equally off of the center of the biasing wheels 42, as shown by position B′, so that biasing mechanism 25 is under greater biasing force when in second position “B” than in an intermediate position between B′ and A′. In this manner, lower end 32 of leg 30 is sufficiently maintained in second position “B” by the resistance of biasing mechanism 25 to forces applied when inadvertent attempts to move leg 30 are made. As illustrated in FIG. 5A, a portion of biasing mechanism 25 is supported in notch 21 of bracket 20 and mated at one end to an off-center opening 27, additionally illustrated in FIG. 6, of wheels 42. It is also preferred that biasing mechanism 25 be mated to off-center opening 27 in such a manner that biasing mechanism 25 is stretched as leg 30 is moved from second position “B” to first position “A.” Because the respective ends of biasing mechanism 25 are offset mounted to biasing wheels 42 with respect to the notches 21 and 23 of brackets 20 and 22, respectively, the biasing mechanism 25 is “over-centered” and serves to keep or securely resiliently bias the legs 30 in both the first position “A” and the second position “B” thereby maintaining the stability of the pivotable leg assembly 10 of the present invention when the legs 30 are in their two extreme operated positions (first position “A” and second position “B”). In this way, biasing mechanism 25 will provide resilient bias against moving out of second position “B” toward first position “A” as leg 30 is pivoted and coupled biasing wheels 42 are thereby rotated.

It should be understood that the resistance of biasing mechanism 25 to forces applied in pivoting leg 30 between first position “A” and second position “B” is sufficient to prevent leg 30 from inadvertently moving between first position “A” and second position “B” and allows leg 30 to be releasably secured in either first position “A” or second position “B.” The strength of the user is employed to overcome the resistance of biasing mechanism 25 in order to place leg 30 in the desired first position “A” or second position “B.”

While the invention has been described in conjunction with a preferred embodiment, it will be apparent to one skilled in the art that other objects and refinements of the disclosed leg assembly may be made within the purview and scope of the subject matter to be protected.

The leg assembly, in its various aspects and disclosed forms, is well adapted to the attainment of the stated features and advantages of others. The disclosed details are not to be taken as limitations of the subject matter sought to be protected, except as those details may be included in the appended claims. The embodiments in which an exclusive property or privilege is claimed are as follows:

What is claimed is:

1. A pivotable leg assembly for use with a colander comprising:
a housing having an engagement end for engaging a colander body;
a leg pivotably engaged to the housing; and
a biasing mechanism coupled to the leg and positioned within the housing;
wherein the biasing mechanism provides resilient bias against pivoting the leg from either a first position or a second position.

2. The pivotable leg assembly according to claim 1, wherein the housing incorporates a lower leg stop.

3. The pivotable leg assembly according to claim 2, wherein the lower leg stop prevents over-rotation of the leg in a first direction.

4. The pivotable leg assembly according to claim 1, wherein the housing incorporates an upper leg stop.

5. The pivotable leg assembly according to claim 4, wherein the upper leg stop prevents over-rotation of the leg in a second direction.

6. The pivotable leg assembly according to claim 1, wherein the leg is pivotably engaged to the housing at an upper end.

7. The pivotable leg assembly according to claim 1, wherein the biasing mechanism includes a shaft and at least one biasing wheel.

8. The pivotable leg assembly according to claim 7, wherein the at least one biasing wheel has an eccentric opening to receive an end of the shaft.

9. A colander assembly comprising:
a colander having a housing coupled thereto;
a leg pivotably engaged to the housing; and
a biasing mechanism coupled to the leg and positioned within the housing;
wherein the biasing mechanism provides resilient bias against pivoting the leg from either a first position or a second position.

10. The pivotable leg assembly according to claim 9, wherein the housing incorporates a lower leg stop.

11. The pivotable leg assembly according to claim 10, wherein the lower leg stop prevents over-rotation of the leg in a first direction.

12. The pivotable leg assembly according to claim 9, wherein the housing incorporates an upper leg stop.

13. The pivotable leg assembly according to claim 12, wherein the upper leg stop prevents over-rotation of the leg in a second direction.

14. The pivotable leg assembly according to claim 9, wherein the leg is pivotably engaged to the housing at an upper end.

15. The pivotable leg assembly according to claim 9, wherein the leg in the first position has a lower end adjacent to the colander.

16. The pivotable leg assembly according to claim 9, wherein the leg in the second position has a lower end away from the colander.

17. The pivotable leg assembly according to claim 9, wherein the biasing mechanism includes a shaft and at least one biasing wheel.

18. The pivotable leg assembly according to claim 17, wherein the at least one biasing wheel has an eccentric opening to receive an end of the shaft.
